(19) United States
(12) Patent Application Publication
(10) Pub. No.: US 2009/0162940 A1
(43) Pub. Date: Jun. 25, 2009

(54) Specimen Analysis Tube

(76) Inventors: Stephen C. Wardlaw, Lyme, CT (US); Robert A. Levine, Guilford, CT (US)

Correspondence Address: O''Shea Getz P.C., 1500 MAIN ST. SUITE 912, SPRINGFIELD, MA, 01115, US

(21) Appl. No.: 11/569,640

(22) PCT Filed: May 17, 2005
(86) PCT No.: PCT/US2005/017310

§ 371 Date: Dec. 5, 2006

Related U.S. Application Data
(60) Provisional application No. 60/574,852, filed on May 28, 2004.

(51) Int. Cl. G01N 1/10; B01L 3/00

(52) U.S. Cl. 436/180; 422/102

(57) ABSTRACT

A method and apparatus for analyzing a fluid sample. More particularly, this relates to a specimen analysis tube (2) for containing the specimen (12) sample and to a method of drawing the specimen sample (12) into the tube (2) by capillary action. When the sample (12) is drawn into the tube (2), air is expelled from the tube (2) in the direction which is counter to the flow of the sample (12) into the tube (2). The tube (2) can be U-shaped or it can be linear and can be disposed in a closed-ended holder (22) that is operative to vent air from the tube (2) in a direction which is counter to the direction of flow of the sample into the tube (2).

This application claims the benefit of U.S. Ser. No. 60/574,852, filed May 28, 2004.

### TECHNICAL FIELD

This invention relates to a method and apparatus for analyzing a fluid sample. More particularly, this invention relates to a specimen analysis tube for containing the specimen sample and to a method of putting the specimen sample in the tube by capillary action.

### BACKGROUND ART

The use of small diameter tubes for analyzing blood or other body fluids has been widely practiced for decades. Perhaps the best known example is the hematocrit wherein a sample of whole anti coagulated blood is drawn into the analysis tube largely by capillary action. The tube and sample is then centrifuged and the length of the separated compacted red blood cell layer is compared to the length of the total volume of the sample to obtain an hematocrit. Such tubes are used millions of times per week and, although they are simple and inexpensive, they suffer from some drawbacks.

One problem encountered when using conventional capillary tubes relates to the filling of the tubes with the sample. With conventional capillary tubes air must be displaced from the tube as the sample enters the tube. This is accomplished by having the distal end of the tube open to the ambient surroundings. After the proper amount of blood has been drawn into the tube, the distal end thereof is plugged by any number of means. Common means for sealing the distal end of the tube include sealing it with a heat source, or using a clay plug to seal it. In both of these cases, care must be taken to ensure that the sample is not denatured, if heat is used, and that the seal is adequate to prevent seepage of the blood sample past the seal during subsequent centrifugation of the sample in the tube. Other closures have been developed to help solve this problem, such as movable plastic closures. These alternatives do not, however eliminate the blood or other fluid seepage problems that may occur during centrifugation of the samples.

Another problem is that the tube manipulation required by traditional methods almost always results in the user's hands or gloves coming into contact with the blood or fluid. Additionally, there is usually a “blob” of blood or fluid remaining on the side of the tube after filling it which must be wiped off of the tube. The blood contamination of the tube and/or the users hands or gloves also can result in contamination of the centrifuge or other instrument with which the tube comes into contact.

Yet another problem with the prior art techniques and paraphernalia is that it is difficult to obtain an accurately measured amount of blood which is less than that contained in the entire tube. Fiduciary lines can be placed on the tube so that the user can regulate the amount of blood drawn but this requires substantial technical skill for the fill to be very accurate, whereby the prior art procedures tend to be undependable except in skilled hands.

For these and other reasons it would be desirable to be able to provide a tube for analyzing samples of blood or other biological fluids, which tube can be filled and its contents can be analyzed without the need for a plugging or capping step. More particularly, it would be desirable to provide a sample analyzing tube which will reduce the chance of blood or sample fluid contamination during filling and handling, and will provide for an accurate fill volume which is less than the total volume of the tube.

### DISCLOSURE OF THE INVENTION

This invention relates to an improved specimen sample analyzing tube which can be used for drawing and analyzing blood or other biological fluid samples. The tube of this invention preferably uses capillary action to draw the sample being analyzed, and can thus be characterized as a capillary tube. The term “capillary” as used herein refers to a small diameter tube into which fluid will be drawn when the tube is held either horizontally or at a slight angle, or to a tube of sufficiently small diameter such that fluid will enter it and flow with an intact leading fluid surface. The tube of this invention can also be characterized as being “bottomless” due to its configuration. The tube has a proximal portion which is used to draw the specimen sample into the tube and a distal portion which is the other end of the tube. In one embodiment of the invention, the tube is U-shaped with the proximal portion of the tube being longer than the distal portion of the tube. The U-shaped configuration of the tube allows it to be filled with the specimen sample and later centrifuged and analyzed without the need of a distal end closure or plug. The result of utilizing a U-shaped tube is that the height of the sample in the proximal portion of the tube is the same as the height of the sample in the distal portion of the tube and air escapes from the tube in a direction which is opposite to the direction that the sample enters the tube. When the tube is filled, both sides of the tube come to an equilibrium levels which match each other. This embodiment is similar to the U-tubes found on early automated analyzers made by the Technicon Corporation, which used such tubes in continuous flow centrifugation methods for determining the hematocrit of a whole blood sample. In those systems, blood samples were continuously pumped through the U-shaped centrifuge tubes while the centrifuge was rotating, while the level of the compacted bed blood cells was continuously monitored.

Another embodiment of the invention utilizes a holder for a capillary tube. The holder has a central bore with a closed lower end. The capillary tube is placed in the holder bore and resides in the holder bore during drawing of the fluid sample. The holder bore includes a small slot formed therein which extends from the dosed lower end of the holder bore to the open upper end of the holder bore. This slot allows air to escape from the capillary tube when the capillary tube is filled with blood or another fluid when the capillary tube is positioned in the holder bore. As in the other embodiment described above, the air in the tube escapes from the tube and holder in a direction which is opposite to the direction which the sample enters the tube. Once the capillary tube is filled, a closure cap can be fitted onto the open end of the holder. The lower end of the tube does not require sealing after the tube is filled with the sample, and during centrifugation of the tube and sample, none of the sample can leak out of the tube.

It is therefore an object of this invention to provide an apparatus and method for analyzing a sample of a biological fluid such as blood in a tube such as a capillary tube.

It is a further object of this invention to provide an apparatus and method of the character described which is eliminates the possibility of one using the apparatus coming into contact with the sample.

It is yet another object of this invention to provide an apparatus and method of the character described wherein the sample is analyzed during or after being centrifuged in the tube.

It is a further object of this invention to provide an apparatus and method of the character described wherein air escapes from the tube during sample filling in a direction which is opposite to the direction that the sample enters the tube.

It is an additional object of this invention to provide an apparatus and method of the character described which is simple to use and requires minimal technician training.

### BRIEF DESCRIPTION OF THE DRAWINGS

These and other objects and advantages of the invention will become more readily apparent from the following detailed description of several embodiments of the invention when taken in conjunction with the accompanying drawings in which:

FIG. 1 is a side elevational view of a first embodiment of a sample analyzing tube which is formed in accordance with this invention where blood has filled a proximal portion of the tube;

FIG. 2 is a view similar to FIG. 1 but showing the sample just after the beginning of centrifugation;

FIG. 3 is a view similar to FIG. 2 but showing the sample after it has been centrifuged in the tube;

FIG. 4 is a view similar to FIG. 1 but showing a modified version of the sample analyzing tube;

FIG. 5 is a view similar to FIG. 4 but showing the tube just after the beginning of centrifugation;

FIG. 6 is a view similar to FIG. 5 but showing the sample after it has been centrifuged in the tube;

FIG. 7 is a side elevational view of a second embodiment of an apparatus formed in accordance with this invention;

FIG. 8 is a cross-sectional view of the apparatus of FIG. 7;

FIG. 9 is a view which illustrates how the assembly of FIG. 7 is used to draw a blood sample from a finger stick;

FIG. 10 is a view similar to FIG. 7 but showing the capillary tube in the assembly after it has been filled with the blood sample;

FIG. 11 is a view similar to FIG. 10 but showing the assembly after the closure cap has been pressed down onto the tube holder and centrifugation of the sample has commenced; and

FIG. 12 is a view similar to FIG. 11 but showing the assembly after the blood sample has been centrifuged in the assembly.

### DESCRIPTION OF SPECIFIC EMBODIMENTS OF THE INVENTION

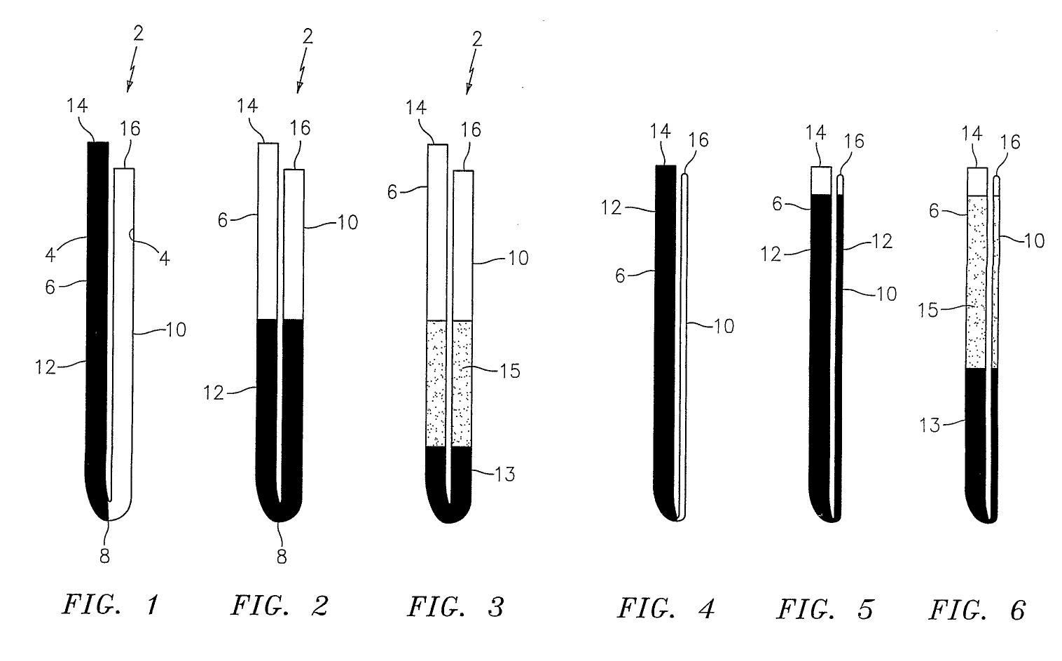

Referring now to FIGS. 1-3 there is shown a first embodiment of a sample analysis tube formed in accordance with this invention, which tube is denoted generally by the numeral 2. The tube 2 is a capillary tube and is generally U-shaped. The tube 2 includes a bore 4 which extends from a first open-ended leg 6 through an open lower end 8 to a second open-ended leg 10. The second leg 10 is preferably shorter than the first leg 6. When the blood sample 12 is drawn into the tube 2 through a first open end 14 of the tube 2, the blood 12 fills the first leg 6 and air in the tube 2 is expelled from the tube 2 through the open end 16 of the second leg 10. Thus air is expelled from the tube 2 in a direction which is counter to the direction of blood flow into the tube 2 instead of in the same direction as with conventional capillary tubes. FIG. 2 shows the position of the anti coagulated blood sample 12 in the tube 2 after the commencement of centrifugation of the blood sample 12. It will be noted that the blood sample 12 becomes evenly distributed in both legs 6 and 10 of the tube 2 once centrifugation of the sample begins. FIG. 3 shows the separation of the red cells 13 from the non-red cell component 15 in the blood sample at the completion of the centrifugation of the blood sample in the tube 2. It will be noted that the red cell columns and the non-red cell columns are equally distributed in each leg 6 and 10 of the tube 2. The tube 2 can be used in the performance of hematocrit and hemoglobin measurements.

Referring now to FIGS. 4-6, there is shown a variation of the U-shaped embodiment of the tube 2 of this invention which results in more of the blood sample 12 being disposed in the leg 6 than in the leg 10. This is accomplished by providing the leg 6 with a larger diameter than the leg 10. The filling and centrifuging steps for the variation shown in FIGS. 4-6 are similar to the steps of filling and centrifugation steps for the variation shown in FIGS. 1-3 but the results of the centrifugation step is different As noted in FIG. 5, at the beginning of the, centrifugation step the levels of the blood sample 12 even out in both legs 6 and 10 of the tube 2. As noted in FIG. 6, after the centrifugation step is completed, the levels of the packed red cell layer 13 in the blood sample 12 are the same in both legs 6 and 10, but more of the packed red cells 13 are disposed in the leg 6 than in the leg 10 due to the difference in the diameter of the bores of the leg 6 and the leg 10. Comparing FIG. 3 and FIG. 6, it is apparent that one need measure only the red cell layer 13 and the plasma layer 15 in the leg 6 to obtain the information needed to derive the hematocrit and hemoglobin values for the blood sample. If the diameter of the leg 10 is made diminutive, the amount of the sample contained in the leg 10 can be ignored in analyzing the blood sample for every purpose. That said, the air in the tube 2 will still be able to be discharged from the tube 2 during the sample filling step through the leg 10.

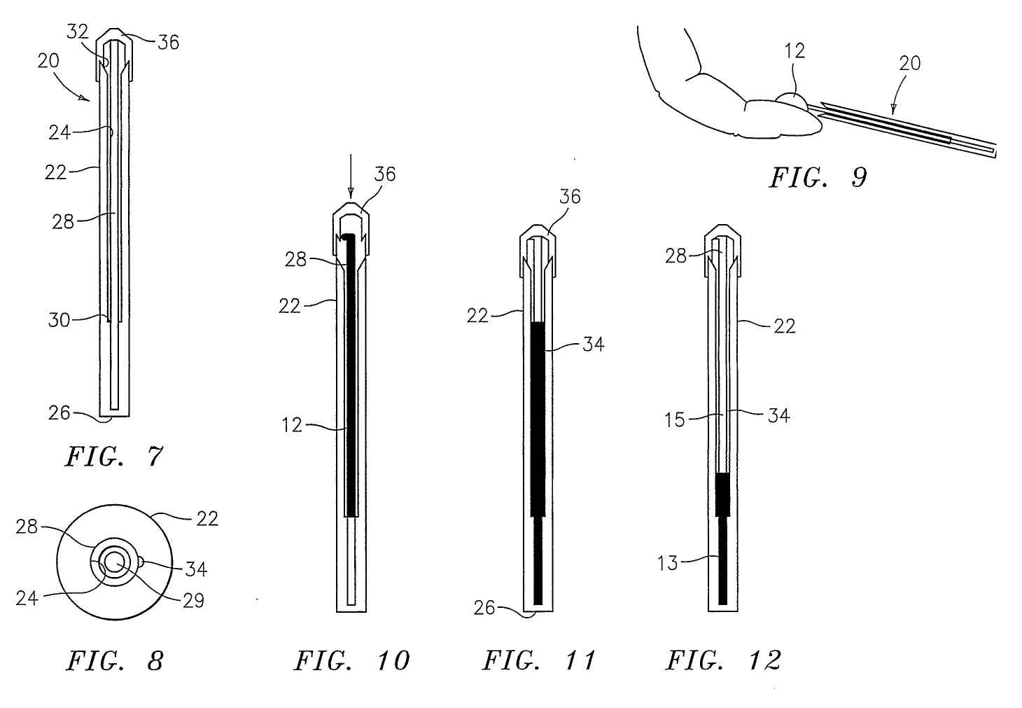

Referring now to FIGS. 7-12, there is shown a second (and preferred) embodiment of a sample-analyzing tube assembly, which assembly is denoted generally by the numeral 20, that is formed in accordance with this invention. The assembly 20 includes a holder 22 having a bore 24 with a closed end 26. A capillary tube 28 is positioned in the holder bore 24. The tube 28 may include a cylindrical float 29 positioned inside of the tube 28. The float 29 will expand buffy coat component layers and will sink into the erythrocyte layer when a blood sample is centrifuged in the assembly. The depth to which the float sinks into the erythrocyte can be used to measure the hemoglobin content of the blood sample, as is described in the prior art. The lower end of the tube 28 rests on a step 30 in the bore 24. The tube 28 projects above an open end 32 of the holder 22. The holder bore 24 includes a slot 34 which extends from the step 30 to the open end 32 of the holder 22. FIG. 9 illustrates how the assembly 20 is used to draw a blood sample from a patient's finger. The blood 12 is drawn into the tube 28 by capillary action, and the air in the tube 28 is expelled therefrom through the slot 34 in the holder 22. After the tube 28 is filled an upper end closure cap 36 is pressed down onto the holder 22 to close the upper end thereof, as shown in FIG. 10. The cap 36 protects the user from coming into contact with the drop of blood that is typically deposited on the outside of the tube 28 during the blood draw. When centrifugation of the blood sample commences, the blood in the tube 28 will gravitate down to the closed end 26 of the holder 22 and some of the blood will be pushed up into the slot 34, as shown in FIG. 11. When the centrifugation step is completed the blood sample will separate into a red cell fraction 13 and a plasma fraction 15 in both the tube 28, the holder 22, and the slot 34, as shown in FIG. 12. It will be noted that the vast majority of the centrifuged blood components will be disposed in the tube 28 and the holder 22, and a diminutive amount of the centrifuged blood components will be disposed in the slot 34. This being the case, the hematocrit and hemoglobin analyses can be made by focussing on the compacted red blood cells in the tube 28 and holder 22 and ignoring the amount of red blood cells disposed in the slot 34.

It will be readily appreciated that the specimen analysis tube of this invention will allow for more accurate volumes of the fluid being analyzed to be drawn into the tube. The analysis tube of this invention will also protect the user from coming into physical contact with the fluid being analyzed in the tube. The tube of this invention likewise does not require the use of a closure cap or plug at the outlet end thereof.

Since many changes and variations of the disclosed embodiments of the invention may be made without departing from the inventive concept, it is not intended to limit the invention otherwise than as required by the appended claims.

1. A fluid specimen sample analysis tube wherein the specimen sample is drawn into the tube by capillary action, said tube comprising:
a) a first leg having a first open end through which the sample is drawn into the tube by capillary action; and
b) a second leg adjacent to and parallel to said first leg, said second leg having a second open end which faces in the same direction as said first open end, said first open end serving as an inlet end for said tube through which a sample is drawn into said tube, and said second open end serving as an outlet end through which air is discharged from said tube during filling of said tube with a sample.

2. The sample analysis tube of claim 1 wherein said first leg is longer than said second leg.

3. The sample analysis tube of claim 1 wherein said first and second legs have approximately the same diameter.

4. The sample analysis tube of claim 1 wherein said second leg has a smaller diameter than said first leg.

5. A fluid specimen sample analysis assembly wherein the specimen sample is drawn into a tube by capillary action, said assembly comprising:
a) an open ended capillary tube for receiving a specimen sample to be analyzed;
b) a holder for said capillary tube, said holder having an internal bore containing said capillary tube, said bore having an open end and a closed end, and said bore having a first portion thereof which snugly receives said capillary tube whereby one end of said capillary tube projects from said bore beyond said open end thereof; and said bore having a second smaller diameter portion thereof which extends from said first portion toward said closed end of said holder; and
c) an axially extending slot in said first portion of said bore, said slot extending from said second portion of said bore to said open end of said bore, said slot providing a passage for air to be exhausted from said capillary tube when a sample is drawn into said capillary tube, whereby air is exhausted from said capillary tube in a direction which is counter to the direction of flow of a sample into said capillary tube.

6. The assembly of claim 5 wherein said slot and said second portion of said bore are operative to receive a portion of a sample drawn into said capillary tube when said sample is centrifuged in said assembly.

7. The assembly of claim 6 further comprising a closure cap fitted onto said open end of said holder bore when said sample and assembly are centrifuged.

8. The assembly of claim 5 further including a radial shoulder between said first and second portions of said holder bore, said shoulder limiting the extent of insertion of said capillary tube into said holder.

9. The assembly of claim 5 further comprising a cylindrical float positioned in said tube.

10. A method for drawing a fluid specimen sample into an open ended capillary tube, said method comprising the steps of:
a) drawing the sample into said capillary tube in a first direction by capillary action; and
b) expelling air from said capillary tube in a direction which is counter to said first direction during said drawing step.

11. The method of claim 10 wherein said capillary tube is U-shaped and wherein both open ends of said capillary tube face in the same direction.

12. A fluid specimen sample analysis tube wherein the specimen sample is drawn into the tube by capillary action, said tube comprising:
a) a first leg having an first open end with a size operable to permit sample to be drawn into the first leg by capillary action; and
b) a second leg adjacent to and parallel to the first leg, the second leg having a second open end which faces in the same direction as the first open end, the first open end serving as an inlet end for the tube through which a sample is drawn into the tube, and the second open end serving as an outlet end through which air is discharged from the tube during filling of said tube with a sample;
c) wherein at least the first leg of the tube is sized so as to be operable for counts of constituents within a blood sample.
